(19) United States
(12) Patent Application Publication
(10) Pub. No.: US 2012/0060729 A1
(43) Pub. Date: Mar. 15, 2012

(54) Slurry distributor

(76) Inventor: Philip Andrew Blake, Tiverton (GB)

(21) Appl. No.: 12/807,816

(22) Filed: Sep. 13, 2010

(51) Int. Cl. A01C 23/02

(52) U.S. Cl. 111/128

(57) ABSTRACT

A slurry distributor comprises a slurry delivery pipe (B) to which, in use, the slurry is supplied, the slurry delivery pipe having a longitudinally extending slot (E). There is an injector rotor (A) within which the slurry delivery pipe (B) is disposed, a plurality of tines (C) and a plurality of outlet ports (D) on the injector rotor (A). The tines (C) are adapted for cutting into the soil upon movement of the injector rotor (A) over the soil surface and the arrangement is such that, as the outlet ports (D) of the injector rotor (A) pass the slot (E) during rotation of the injector rotor (A) relative to the slurry delivery pipe (B), the slurry will pass through the slot (E) into the outlet ports (D).

### FIELD OF THE INVENTION

This invention relates to slurry distributors and has for its object the provision of an improved form of slurry distributor.

Environment regulations are becoming increasingly strict and it is accordingly a more specific object of the present invention to provide a slurry distributor that is designed to comply with existing and future legislation relating to the spreading of slurry.

Further objects of the present invention include the provision of a slurry distributor that can handle varying consistencies of liquid slurry, can handle a high flow rate of liquid slurry and, at the same time, distribute it evenly.

A further object of the present invention is the provision of a simple and effective method of spreading slurry leading to a greater uptake of nitrogen by growing crops from the slurry.

### SUMMARY OF THE INVENTION

According to a first aspect of the present invention there is provided a slurry distributor comprising a slurry delivery pipe to which, in use, the slurry is supplied, the slurry delivery pipe having a longitudinally extending slot, an injector rotor within which the slurry delivery pipe is disposed, and a plurality of tines and a plurality of outlet ports on the injection rotor, the tines being adapted for cutting into the soil upon movement of the injector rotor over the soil surface and the arrangement being such that, as the outlet ports of the injector rotor pass the slot during rotation of the injector rotor relative to the slurry delivery pipe, the slurry will pass through the slot into the outlet ports.

According to a second aspect of the present invention there is provided a method of spreading slurry that includes the use of a distributor as defined above.

### BRIEF DESCRIPTION OF THE DRAWINGS

FIG. 1 is a sectional view of a slurry delivery pipe and an injector rotor of a slurry distributor in accordance with the present invention,

FIG. 2 is an exploded perspective view of the slurry distributor pipe and injector rotor of FIG. 1,

FIG. 3 is a schematic side view of the slurry distributor in use, and

FIG. 4 is a schematic view illustrating the possible directions of flow of the slurry.

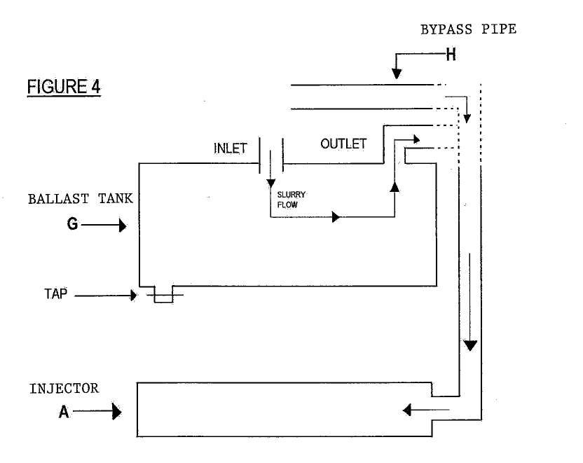

### DESCRIPTION OF THE PREFERRED EMBODIMENT

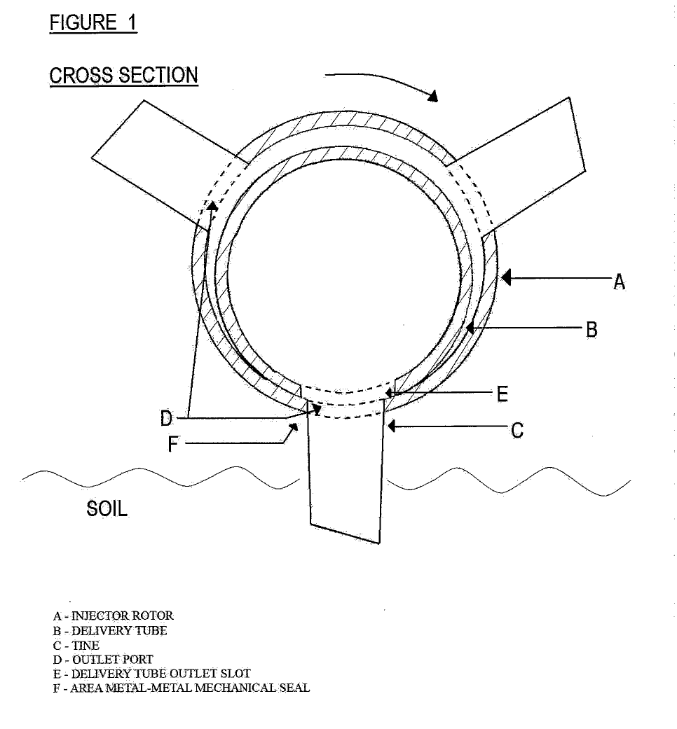

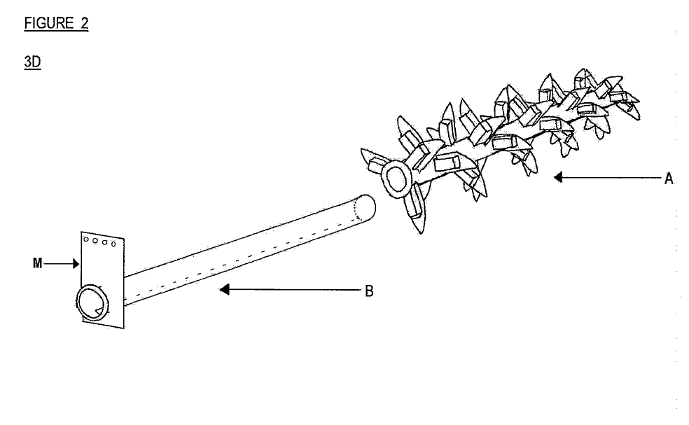

Referring first to FIGS. 1 and 2, these show a cylindrical slurry delivery pipe B on which an injector rotor A is freely rotatably mounted. The downwardly facing portion of the slurry delivery pipe B is formed with an elongated slot E that extends for substantially the whole length of the pipe B. The injector rotor A carries a plurality of tines C that project from the surface of the rotor A and each tine C comprises a flat ground-penetrating blade located adjacent a rectangular section hollow conduit. The radially inner ends of the conduits serve as outlet ports D through which the liquid slurry can flow when each respective outlet port D is aligned with the downwardly facing elongated slot E.

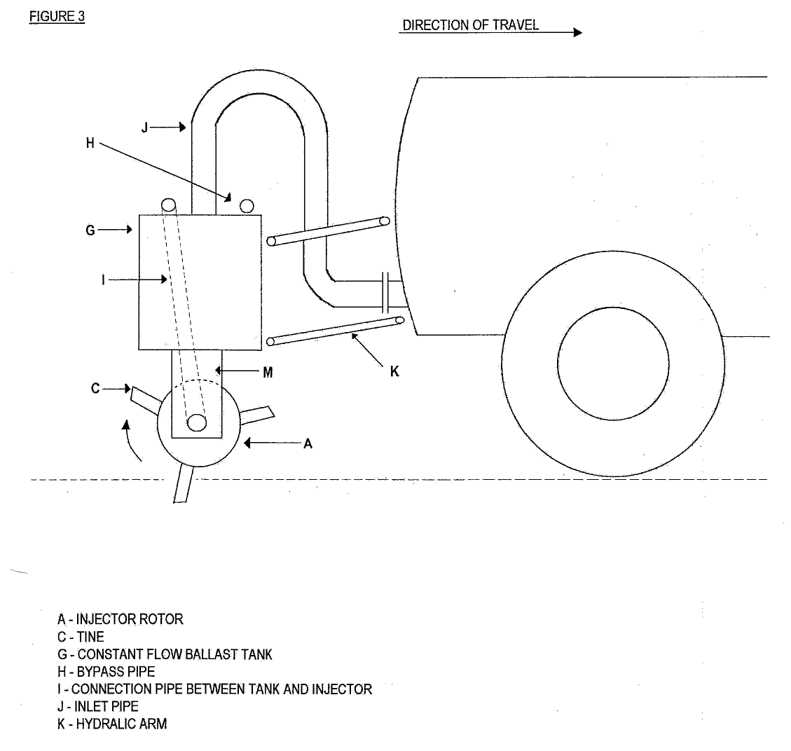

As the slurry distributor is pulled across the ground, in the manner shown in FIG. 3, the injector rotor A rotates relative to the delivery pipe B and, when an outlet port D is in alignment with the elongated slot E, the slurry within the delivery pipe B flows through the slot E and the aligned outlet port D into the hollow conduit adjacent the associated tine C and thence to the ground. As can be seen from FIG. 2, the tines C and the outlet ports D are spread substantially evenly along the length of the injector rotor A in a generally spiral formation and thus the slurry is applied substantially evenly on the ground over which the distributor has travelled. Penetration of the ends of the tines C into the ground creates cavities in the ground ensuring that the slurry can enter the ground (and not remain solely on the surface) thereby ensuring better uptake of the nutrients within the slurry by the root systems of growing crops.

If the liquid slurry contains fibrous materials, a chopping action will be provided as the outlet ports D of the tines C pass the elongated slot E as the rotor A rotates relative to the delivery pipe B. This will serve to cut up any fibrous materials within the slurry and will promote even spreading of the slurry.

Large metal washers (not shown) are disposed at the two ends of the delivery pipe B and provide a mechanical seal between the delivery pipe B and the injector rotor A. A metal to metal mechanical seal is also produced at F (see FIG. 1) and this is constantly lubricated by the constant flow of liquid slurry material passing through the elongated slot E.

As shown in FIG. 3, the slurry delivery pipe A is carried by a bracket M beneath a ballast tank G mounted by means of hydraulic support arms K behind a tanker containing slurry. The liquid slurry flows from the tanker into a ballast tank G along an inlet pipe J and there is a connection pipe I for the flow of slurry from the ballast tank G to the delivery pipe A. There is also a by-pass pipe H for the direct flow of slurry from the tanker to the delivery pipe A.

The use of the ballast tank G serves to increase the load carried by the hydraulic arms K and thus the downward force applied to the tines C when they penetrate the surface of the soil. The ballast tank G will normally be required when applying slurry to relatively hard, dry ground.

The arrangement is such that, if required, the slurry can flow directly from the tanker to the delivery pipe A via the by-pass pipe H. During most operations, however, the slurry flows at a constant rate into the ballast tank G serving to fill the ballast tank G before flowing on to the delivery pipe A.

When desired, the ballast tank G can be drained by opening a tap located underneath the ballast tank G. This will reduce the mass of the slurry injector for transportation or storage or for a significant change in ground conditions.

1. A slurry distributor comprising a slurry delivery pipe to which, in use, the slurry is supplied, the slurry delivery pipe having a longitudinally extending slot, an injector rotor within which the slurry delivery pipe is disposed, and a plurality of tines and a plurality of outlet ports on the injection rotor, the tines being adapted for cutting into the soil upon movement of the injector rotor over the soil surface and the arrangement being such that, as the outlet ports of the injector rotor pass the slot during rotation of the injector rotor relative to the slurry delivery pipe, the slurry will pass through the slot into the outlet ports.

2. A slurry distributor as claimed in claim 1, in which the tines are arranged spirally.

3. A slurry distributor as claimed in claim 1, in which each tine comprises a ground-penetrating blade.

4. A slurry distributor as claimed in claim 1, in which the slurry delivery pipe and the injector rotor are mounted beneath a ballast tank.

5. A slurry distributor as claimed in claim 4, in which the slurry delivery pipe is fixed and the injector rotor rotates relative to the delivery pipe.

6. A method of spreading slurry that includes the use of a distributor as claimed in claim 1.
